(19) United States
(12) Patent Application Publication
(10) Pub. No.: US 2015/0167769 A1
(43) Pub. Date: Jun. 18, 2015

(54) LINEAR DAMPER

(71) Applicant: CHI HUA FITNESS CO., LTD., Hsinchu County (TW)

(72) Inventor: YING-CHE LEE, HSINCHU COUNTY (TW)

(73) Assignee: CHI HUA FITNESS CO., LTD., Hsinchu County (TW)

(21) Appl. No.: 14/105,289

(22) Filed: Dec. 13, 2013

(51) Int. Cl. F16F 6/00

(52) U.S. Cl. CPC F16F 6/005

(57) ABSTRACT

A linear damper, particularly to convert the linear displacement motion into the circular rotation motion for getting magnetic reluctance, comprising: a tube body and a driving rod being movable in the tube body; wherein the driving rod in the first axial passage is in the linear displacement motion, and the screw rod is rotated by the screw sleeve to drive the fixed seat for rotation, so that the permanent magnet is in a circular rotation motion; a torque is produced by Eddy load formed between the permanent magnet and the magnetic surface to be as a buffering and damping of the linear displacement motion of the driving rod, solving oil leakage problem and ensuring the service life and quality.

### BACKGROUND OF THE INVENTION

1. Field of the Invention

The invention relates to a linear damper, particularly to a non-hydraulic damper being able to convert the linear displacement motion into the circular rotation motion for getting magnetic reluctance.

2. Description of the Related Art

In Indoor sports or rehabilitation equipment, some actuating mechanism must be set for the load device or damping device, such as rowing fitness, strength training machines, and etc. A foot sports equipment 10 as show in FIG. 1A has a seat 11, two pedals 12 arranged on the seat 11 for stepping thereon, and a damping device 13 respectively connected between two pedals 12 and the seat 11. The indoor sports equipment is limited to space, so the damping device 13 is mostly used in the hydraulic cylinder as shown in FIG. 1B.

This type of hydraulic cylinder generally includes: a cylinder 131, a piston 132 installed in the cylinder 131, and having a passage 133 thereon and a piston rod 134 at an end thereof, and a predetermined quantity of hydraulic oil 135 filled in the cylinder 131. When the piston rod 134 is subjected to an axial force for linear displacement in the cylinder 131, the hydraulic oil 135 passes through the passage 133 on the piston 132 to produce the damping effect.

The piston rod 134 of the conventional hydraulic damping device 13 with a back and forward motion has frequent friction with an oil seal 136, resulting oil leakage problem fouling ground and equipment, and affecting the damping function. Moreover, after a period of using the hydraulic oil, the viscosity of the hydraulic oil will change, and it is susceptible to high temperatures, resulting in instability damping effect. Due to the hydraulic oil will flow from the piston side to the other side, the response speed of the exchanging path for “stretch” turning to “shrink” or “shrink” turning to “stretch,” is slow, resulting in poor performance of the exercise equipment.

### SUMMARY OF THE INVENTION

It is an object of the present invention to provide a linear damper solve the oil leakage problem of prior art, and to ensure the service life and quality.

It is another object of the present invention to provide a linear damper which is very stable and has damping effect unaffected by the long-term use and the surrounding environment.

It is the other object of the present invention to provide a linear damper is able to respond quickly and always maintain a balance damping for effectively performing the exercise equipment during the “stretch” or “shrink” path.

In order to achieve the above objects, the linear damper comprises a tube body, respectively having a first through hole and a second through hole at both ends, and a first axial passage formed between the first through hole and second through hole; a driving rod, having an inner side end and an outer side end, the outer side end projecting outside the first trough hole and having a first pivot portion, and the inner side end being movable in the tube body; wherein

the second through hole of the tube body has a first bearing at an inner periphery thereof; the driving rod has a hollow section forming a second axial passage, and the inner side end of the driving rod has a third through hole connected to the second axial passage; a screw sleeve is arranged in the second axial passage to be in a linear displacement and linkage state with the driving rod; a screw rod includes a thread section screwing with the screw sleeve, and a shaft section projecting outside the driving rod and set in the first bearing for rotating the screw rod; a fixed seat has an inner ring portion and an outer ring portion, the inner ring portion is set at the shaft section and is rotated with the shaft section, and the outer ring portion has a permanent magnet around the outer surface thereof; a cover is combined with the second through hole of the tube body, and has a second pivot portion at an outer surface thereof, an opening at an inner surface thereof corresponding to the second through hole to combine with the second through hole, and a magnetic surface at an inner periphery thereof corresponding to the permanent magnet to couple with the permanent magnet, an annular gap is formed between the permanent magnet and the magnetic surface;

whereby when the first pivot portion and the second pivot portion are subjected to an axial force, the driving rod in the first axial passage is in the linear displacement motion, and the screw rod is rotated by the screw sleeve to drive the fixed seat for rotation, so that the permanent magnet is in a circular rotation motion; a torque is produced by Eddy load formed between the permanent magnet and the magnetic surface to be as a buffering and damping of the linear displacement motion of the driving rod.

Further, the magnetic surface is an annular magnetic member fixed at an inner periphery of the cover.

Further, the cover has a positioning recess therein to place a second bearing for setting an outer end of the shaft section of the screw rod.

Further, the first through hole of the tube body further includes a first axial sleeve nested in an outer port of the tube body, and a bush is arranged between an inner surface of the first axial sleeve and an outer diameter of the driving rod.

Further, the second through hole of the tube body further includes a second axial sleeve nested in an inner port of the tube body; the second axial sleeve has an inner surface for setting the first bearing, and an outer surface forming a flange larger than an outer diameter of the tube body; the flange has an outer periphery for combining with the opening of the cover.

In the embodiment, the screw sleeve is a small section fixed at the second axial passage close to the position of the inner side end. In another embodiment, the screw sleeve is integrally molded and set at an inner surface of the first axial passage.

Based on the features disclosed, the linear displacement motion of the driving rod is converted into the circular rotation motion of the permanent magnet, and the Eddy load is formed between the permanent magnet and magnetic surface to produce torque in order to replace the magnetic reluctance by the conventional hydraulic oil for solving oil leakage problem and ensuring the service life and quality. The present invention is unlike the conventional hydraulic cylinder having the drawback of the slow response, and uses the spiral features to improve the lead, such that whether it is a “stretch” or “shrink” of the path, the present invention is able to respond quickly and always maintain a balance damping for effectively performing the exercise equipment.

### BRIEF DESCRIPTION OF THE DRAWINGS

FIG. 1A is an appearance schematic view of a conventional fitness equipment;

FIG. 1B is a sectional view of the conventional hydraulic cylinder structure;

FIG. 2 is an appearance schematic view of the preferred embodiment of the present invention;

FIG. 3 is an exploded perspective view of the preferred embodiment of the present invention;

FIG. 4 is a sectional view, showing the present invention in a linear shrinkage displacement movement;

FIG. 4A is a cross-section view taken along the line 4A-4A in FIG. 4;

FIG. 5 is a sectional view, showing the present invention in a linear stretching displacement motion;

FIG. 5A is a cross-section view taken along the line 5A-5A in FIG. 5; and

FIG. 6 is a comparison curve chart of the damping change of the conventional hydraulic cylinder and the present invention.

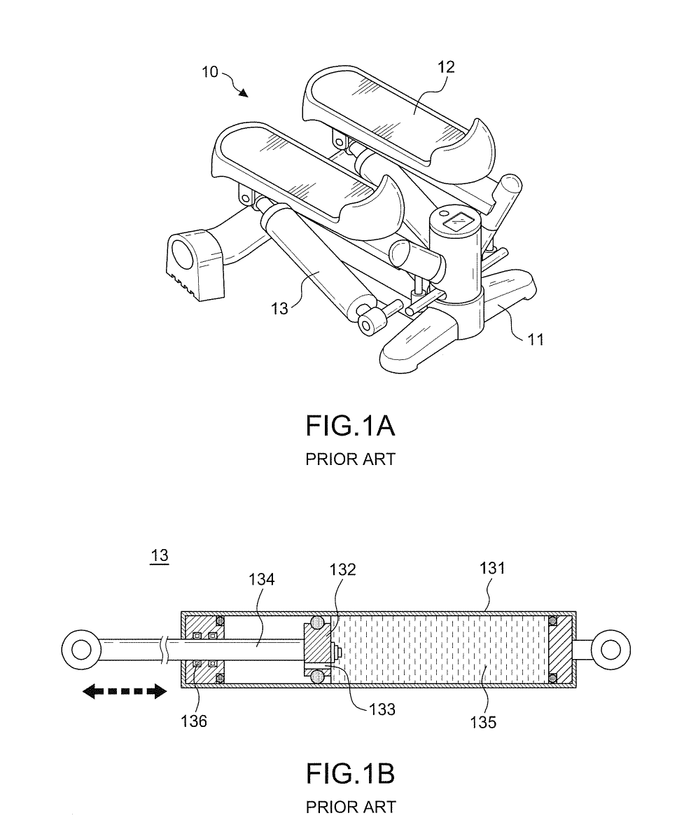

### DETAILED DESCRIPTION OF THE PREFERRED EMBODIMENT

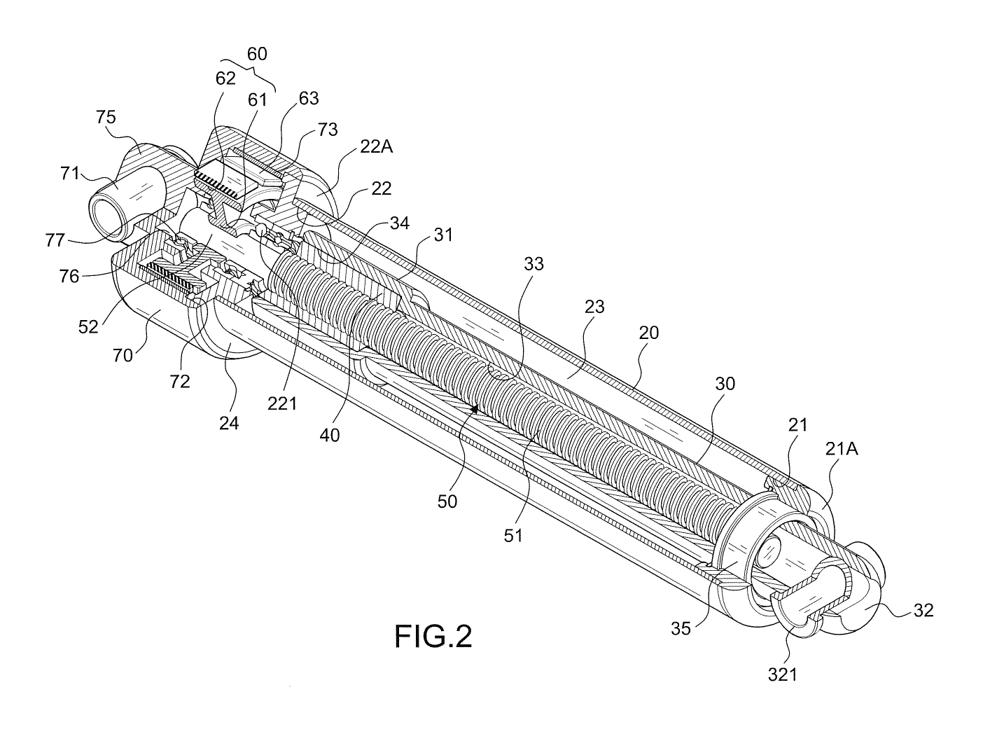

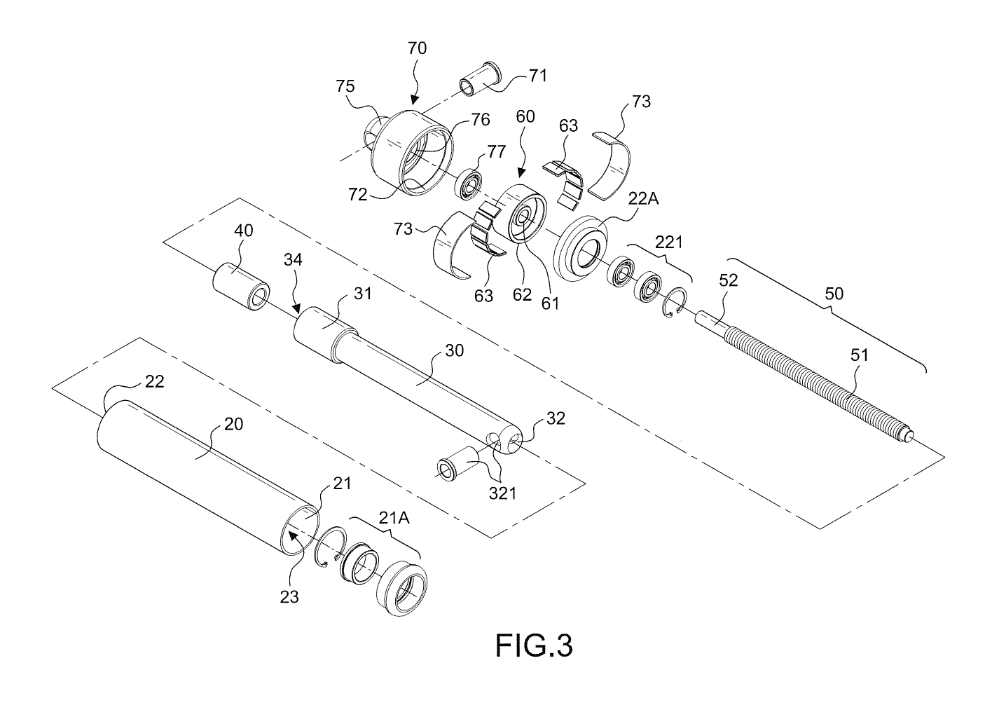

Referring to FIGS. 2 through 5, the preferred embodiment of a linear damper in accordance with the present invention comprises a tube body 20 respectively having a first through hole 21 and a second through hole 22 at both ends, and a first axial passage 23 formed between the first through hole and second through hole 21, 22; a driving rod 30 having an inner side end 31 and an outer side end 32, the outer side end 32 projecting outside the first trough hole 21 and having a first pivot portion 321, and the inner side end 31 being movable in the tube body 20. The structure disclosed above is prior art and thus will not be described in details here.

The present invention is characterized in that the second through hole 22 of the tube body 20 has a first bearing 221 at an inner periphery thereof; in the embodiment, the first through hole 21 of the tube body 20 further includes a first axial sleeve 21A nested in an outer port of the tube body 20, and a bush 35 is arranged between an inner surface of the first axial sleeve 21A and an outer diameter of the driving rod 30. The second through hole 22 of the tube body 20 further includes a second axial sleeve 22A nested in an inner port of the tube body 20; the second axial sleeve 22A has an inner surface for setting the first bearing 221, and an outer surface forming a flange 24 larger than an outer diameter of the tube body 20.

The driving rod 30 has a hollow section forming a second axial passage 33, and the inner side end 31 of the driving rod 30 has a third through hole 34 connected to the second axial passage 33; in the embodiment, the first pivot portion 321 is an oil-bearing or tube passing through the outer side end 32 of the driving rod 30 in a vertical direction.

A screw sleeve 40 is arranged in the second axial passage 33 to be in a linear displacement and linkage state with the driving rod 30; in the embodiment, the screw sleeve 40 is a small section fixed at the second axial passage 33 close to the position of the inner side end 31. At this time, the inner side end 31 has a larger pipe diameter for fixing the screw sleeve 40 but it is not a limitation. In another applicable embodiment, the screw sleeve 40 can be integrally molded and set at an inner surface of the first axial passage 23.

A screw rod 50 includes a thread section 51 screwing with the screw sleeve 40, and a shaft section 52 projecting outside the driving rod 30 and set in the first bearing 221 for rotating the screw rod 50.

A fixed seat 60 has an inner ring portion 61 and an outer ring portion 62, the inner ring portion 61 is set at the shaft section 52 and is rotated with the shaft section 52, and the outer ring portion 62 has a plurality of permanent magnets 63 around the outer surface thereof; in the embodiment, the permanent magnet 63 is composed of a plurality of rubidium magnets. This type of magnet is strong magnet. A small area of this magnet has a strong magnetic force, and therefore it is particularly suitable for the present invention, but not limited thereto.

A cover 70 is combined with the second through hole 22 of the tube body 20, and has a second pivot portion 71 at an outer surface thereof, in the embodiment, the second pivot portion 71 is an oil-bearing or tube passing through a convex lug 75 of a top surface of the cover 70 in a vertical direction. The cover 70 includes an opening 72 at an inner surface thereof corresponding to the second through hole 22 to combine with the second through hole 22. The opening 72 of the cover 70 is used to combine with an outer periphery of the flange 24. The cover 70 further includes a magnetic surface 73 at an inner periphery thereof corresponding to the permanent magnet 63 to couple with the permanent magnet 63, an annular gap 74 is formed between the permanent magnet 63 and the magnetic surface 73. In the embodiment, the magnetic surface 73 is an annular magnetic member which consists of two pieces of semicircular copper, and then is fixed at an inner periphery of the cover 70 but it is not a limitation. In the embodiment, the cover 70 has a positioning recess 76 therein to place a second bearing 77 for setting an outer end of the shaft section 52 of the screw rod 50, so that rotation of the screw rod is more stable.

Whereby when the first pivot portion 321 and the second pivot portion 71 are subjected to an axial force, the driving rod 30 in the first axial passage 23 is in the linear displacement motion, and the screw rod 50 is rotated by the screw sleeve 40 to drive the fixed seat 60 for rotation, so that the permanent magnet 63 is in a circular rotation motion; a torque is produced by Eddy load formed between the permanent magnet 63 and the magnetic surface 73 to be as a buffering and damping of the linear displacement motion of the driving rod 30.

The above damper using the magnetron load is an eddy current resistance formed by using changes in the magnetic field. Its fundamental principle is using a conductive metal plate and moving it through a magnetic field. The magnetic fields opposing the change, or so called “eddy current.” Moreover, according to Maxwell's Equation, the intensity of the magnetic force is in direct proportion to the square of magnetic flux density. The magnetic force can be applied to the exercise machine's damping or buffering.

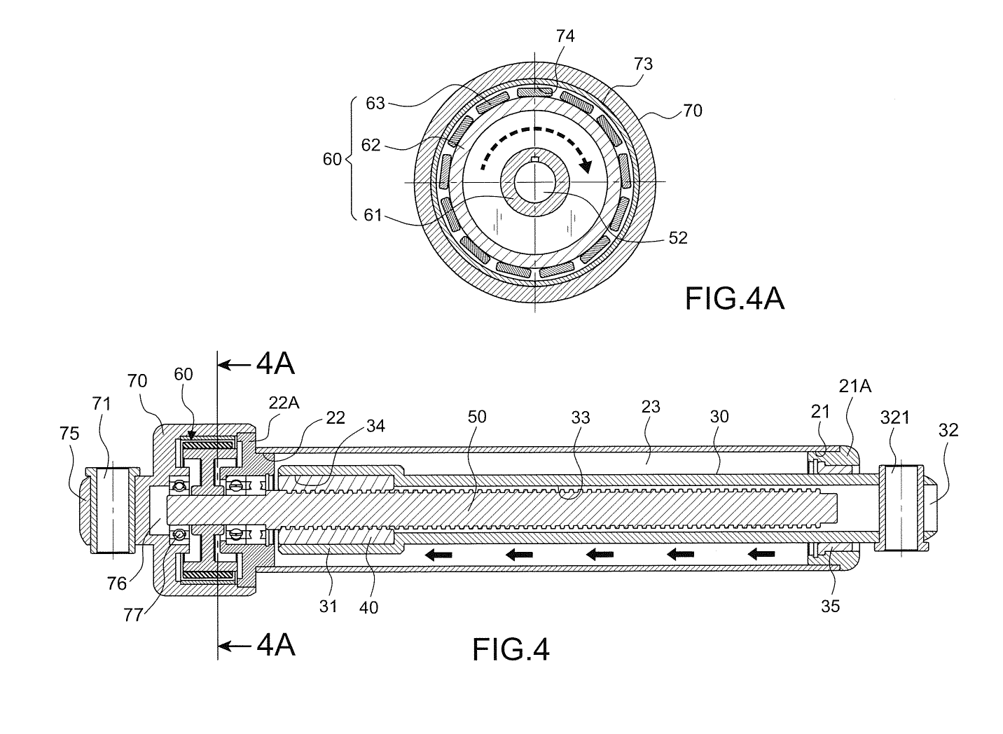

FIGS. 4 and 4A are sectional views, showing that the driving rod 30 is pushed to be in linear shrinkage displacement movement toward the first axial passage 23 of the tube body 20. The screw rod 50 is rotated by the screw sleeve 40 to drive the fixed seat 60 rotating in clockwise direction (or counterclockwise direction) for the permanent magnet 63 to be in the circular rotation motion, and then torque is produced by Eddy load formed between the magnetic surface 73 and the annular gap 74. When the driving rod 30 is in the linear shrinkage displacement movement, the damping (load) is formed from the torque of the circular rotation motion of the permanent magnet 63. The damping (load) from such magnetic reluctance does not required to use the conventional hydraulic cylinder, so there is no oil leakage problem.

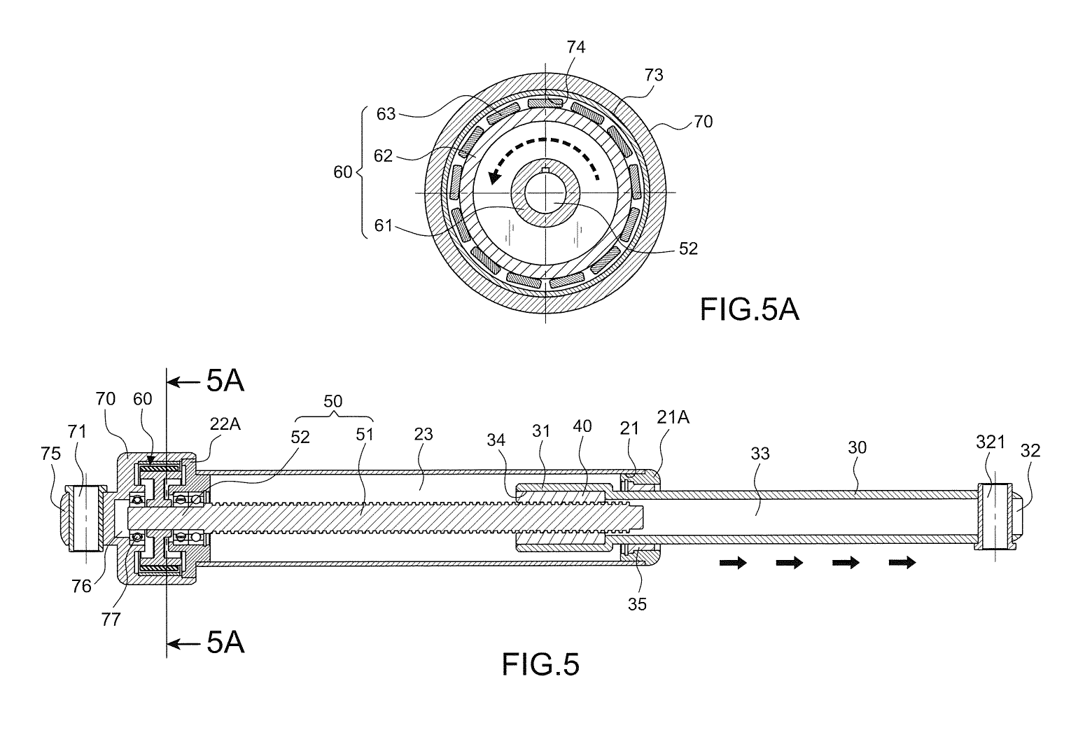

FIGS. 5 and 5A are sectional views, showing that the driving rod 30 is pulled to be in linear stretching displacement movement toward the outer side of the tube body 20. At this point, the screw rod 50 is rotated by the screw sleeve 40 which is in the outward displacement to drive the screw rod rotated in reverse direction for the fixed seat 60 rotating in counterclockwise direction. The present invention is unlike the conventional hydraulic cylinder having the drawback of the slow response, and uses the spiral features to improve the lead, such that whether it is a “stretch” or “shrink” of the path, the present invention is able to respond quickly and always maintain a balance damping for effectively performing the exercise equipment.

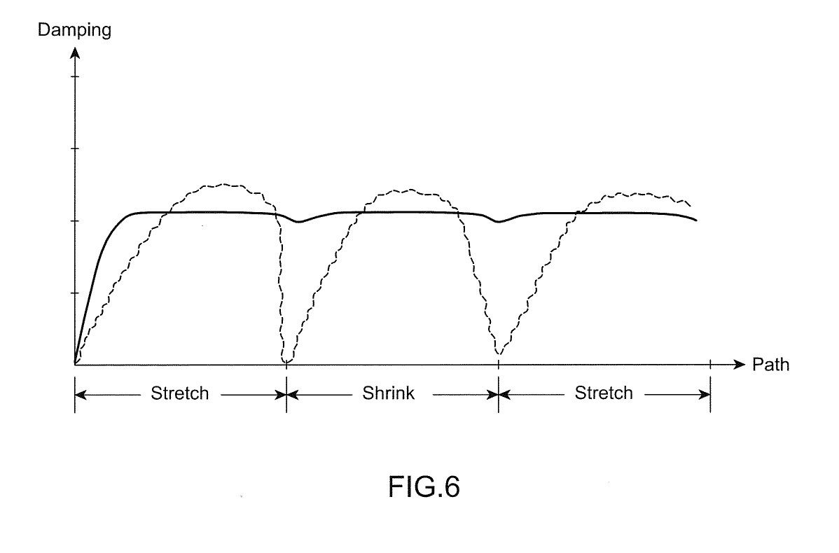

FIG. 6 is a comparison curve chart of the damping change of the conventional hydraulic cylinder and the present invention. The solid line represents the damping of the present invention, and the broken line represents the damping of the hydraulic cylinder. The figure shows that the damping value of the hydraulic cylinder during “stretch” or “shrink” path is not the same. Due to the displacement of the piston rod, hydraulic oil will flow from the piston side to the other side. Especially in the exchanging path of “stretch” turning to “shrink” or “shrink” turning to “stretch,” the user must wait for the return of hydraulic oil, and thus the response speed and the value of the damping is obviously different. In contrast, the damping of the present invention is very stable because the Eddy reluctance (damping) formed at the annular gap 74 between the permanent magnet 63 and magnetic surface 73 is a pre-set stable value, and the present invention uses the spiral features to improve the lead. Therefore, whether the present invention is in a “stretch” or “shrink” path, the present invention is able to respond quickly and always maintain a balance damping effect for effectively performing the exercise equipment.

Based on the features disclosed, the linear displacement motion of the driving rod is converted into the circular rotation motion of the permanent magnet, and the Eddy load is formed between the permanent magnet and magnetic surface to produce torque in order to replace the magnetic reluctance by the conventional hydraulic oil for solving oil leakage problem and ensuring the service life and quality.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A linear damper, particularly to convert the linear displacement motion into the circular rotation motion for getting magnetic reluctance, comprising:
a tube body, respectively having a first through hole and a second through hole at both ends, and a first axial passage formed between the first through hole and second through hole;
a driving rod, having an inner side end and an outer side end, the outer side end projecting outside the first trough hole and having a first pivot portion, and the inner side end being movable in the tube body; wherein
the second through hole of the tube body has a first bearing at an inner periphery thereof;
the driving rod has a hollow section forming a second axial passage, and the inner side end of the driving rod has a third through hole connected to the second axial passage;
a screw sleeve is arranged in the second axial passage to be in a linear displacement and linkage state with the driving rod;
a screw rod includes a thread section screwing with the screw sleeve, and a shaft section projecting outside the driving rod and set in the first bearing for rotating the screw rod;
a fixed seat has an inner ring portion and an outer ring portion, the inner ring portion is set at the shaft section and is rotated with the shaft section, and the outer ring portion has a permanent magnet around the outer surface thereof;
a cover is combined with the second through hole of the tube body, and has a second pivot portion at an outer surface thereof, an opening at an inner surface thereof corresponding to the second through hole to combine with the second through hole, and a magnetic surface at an inner periphery thereof corresponding to the permanent magnet to couple with the permanent magnet, an annular gap is formed between the permanent magnet and the magnetic surface;
whereby when the first pivot portion and the second pivot portion are subjected to an axial force, the driving rod in the first axial passage is in the linear displacement motion, and the screw rod is rotated by the screw sleeve to drive the fixed seat for rotation, so that the permanent magnet is in a circular rotation motion; a torque is produced by Eddy load formed between the permanent magnet and the magnetic surface to be as a buffering and damping of the linear displacement motion of the driving rod.

2. The linear damper as claimed in claim 1, wherein the permanent magnet is composed of a plurality of rubidium magnets.

3. The linear damper as claimed in claim 1, wherein the magnetic surface is an annular magnetic member fixed at an inner periphery of the cover.

4. The linear damper as claimed in claim 1, wherein the cover has a positioning recess therein to place a second bearing for setting an outer end of the shaft section of the screw rod.

5. The linear damper as claimed in claim 1, wherein the first through hole of the tube body further includes a first axial sleeve nested in an outer port of the tube body, and a bush is arranged between an inner surface of the first axial sleeve and an outer diameter of the driving rod.

6. The linear damper as claimed in claim 1, wherein the second through hole of the tube body further includes a second axial sleeve nested in an inner port of the tube body; the second axial sleeve has an inner surface for setting the first bearing, and an outer surface forming a flange larger than an outer diameter of the tube body; the flange has an outer periphery for combining with the opening of the cover.

7. The linear damper as claimed in claim 1, wherein the first pivot portion is an oil-bearing or tube passing through the outer side end of the driving rod in a vertical direction.

8. The linear damper as claimed in claim 1, wherein the second pivot portion is an oil-bearing or tube passing through a convex lug of a top surface of the cover in a vertical direction.

9. The linear damper as claimed in claim 1, wherein the screw sleeve is a small section fixed at the second axial passage close to the position of the inner side end.

10. The linear damper as claimed in claim 1, wherein the screw sleeve is integrally molded and set at an inner surface of the first axial passage.
